(19) United States
(12) Patent Application Publication
(10) Pub. No.: US 2025/0139521 A1
(43) Pub. Date: May 1, 2025

(54) METHOD AND DEVICE FOR UPDATING ARTIFICIAL INTELLIGENCE MODEL BASED ON AUTOMATIC LABELING

(71) Applicant: Kaler Co., Ltd., Seoul (KR)

(72) Inventor: Kyohyuk LEE, Seongnam0si (KR)

(73) Assignee: Kaler Co. Ltd., Seoul (KR)

(21) Appl. No.: 18/923,022

(22) Filed: Oct. 22, 2024

(30) Foreign Application Priority Data
Oct. 31, 2023 (KR) 10-2023-0148269

(51) Int. Cl. G06N 20/00

(52) U.S. Cl. CPC G06N 20/00

(57) ABSTRACT

An artificial intelligence model updating method includes collecting a new dataset generated by performing at least one task using an artificial intelligence model, selecting an update dataset from entire dataset consisting of the initial dataset and multiple unit data of the new dataset, and generating a label of the update dataset based on an output of the artificial intelligence model trained using the initial dataset, wherein a process of reselecting the update dataset until the artificial intelligence model performance is converged and generating a label of the reselected update dataset is performed repeatedly, and thus, automatic labeling with an accuracy almost comparable to manual labeling performed by human may be provided.

### CROSS-REFERENCE TO RELATED APPLICATION

This application is based on and claims priority under 35 U.S.C. § 119 to Korean Patent Application No. 10-2023-0148269, filed on Oct. 31, 2023, in the Korean Intellectual Property Office, the disclosure of which is incorporated by reference herein in its entirety.

### BACKGROUND

The present disclosure relates to a method and device for updating an artificial intelligence model through modeling and training of the artificial intelligence model.

Recently, the use of artificial intelligence models in various industrial fields has been rapidly increased. In order to build an artificial intelligence model, a large amount of data to be used for training the artificial intelligence model has to be collected, and labeling task for the collected data has to be performed in advance. When a large amount of data to be used for training the artificial intelligence model is prepared, hyperparameter design suitable for a training dataset and structure design of the artificial intelligence model have to be performed. Because this series of tasks were performed manually by people, a lot of time and manpower had to be invested in building the artificial intelligence model.

Research is actively being conducted to automate a series of tasks for building an artificial intelligence model. For example, Korean Patent No. 10-2579116, “Apparatus for Cloud-based Artificial Intelligence Automatic Learning and Distribution and Method Therefor,” suggests a technology that automatically performs artificial intelligence learning and distribution with just a few clicks. Korean Patent No. 10-2579116, “Apparatus and method for automatically learning and distributing artificial intelligence based on the cloud” discloses technology that separates some of data into learning data and automatically performs data labeling on objects in the data through automatic learning of data for learning.

However, the conventional technology is limited to data labeling and automating of a learning process, and thus, a great deal of time and manpower still has to be invested in building an artificial intelligence model. In addition, a facility or environment of an industrial infrastructure to which an artificial intelligence model is applied changes over time. There is a problem in that an artificial intelligence model designed according to an initial facility or environment of the industrial infrastructure has performance, such as prediction accuracy, that is gradually decreased over time.

### SUMMARY

The present disclosure provides a method and device for updating an artificial intelligence model so as to provide a prediction result of high accuracy with an optimal and efficient structure even when a facility change or environment change in an industrial infrastructure to which the artificial intelligence model is applied occur based on automatic labeling. The present disclosure is not limited to the technical tasks described above, and other technical tasks may be derived from the following descriptions.

According to an aspect of the present disclosure, an artificial intelligence model updating method includes collecting a new dataset generated by performing at least one task using an artificial intelligence model trained using an initial dataset; selecting an update dataset from entire dataset consisting of multiple unit data of the initial dataset and multiple unit data of the collected new dataset; generating a label of the update dataset based on an output of the artificial intelligence model trained using the initial dataset; and determining whether an artificial intelligence model performance is converged based on a difference between an output of an artificial intelligence model trained using the update dataset and a label of the update dataset, wherein a process of reselecting the update dataset and generating a label of the reselected update dataset is performed repeatedly until the performance of the artificial intelligence model is converged.

In the generating of the label of the update dataset, the label of the update dataset may be generated by setting at least one label value for each of multiple unit data belonging to the collected new dataset among multiple unit data of the selected update dataset.

In the generating of the label of the update dataset, by inputting each of multiple unit data belonging to the collected new dataset to the artificial intelligence model trained using the initial dataset, at least one prediction value for each unit data may be obtained as an output of an artificial intelligence model according to the input of the each unit data, and at least one prediction value for the obtained each unit data may be set as at least one label value for the each unit data.

The artificial intelligence model updating method may further include building an artificial intelligence model according to the initial dataset by training the artificial intelligence model using the initial dataset, wherein, in the selecting of the update dataset, a first update dataset may be selected from the entire dataset, and in the generating of the label of the update dataset, a label of the first update dataset may be generated based on the output of the artificial intelligence model built according to the initial dataset, and in the determining of whether the artificial intelligence model performance is converged, whether the artificial intelligence model performance is converged may be determined based on a difference between an output of an artificial intelligence model trained using the first update dataset and the label of the first update dataset.

The artificial intelligence model updating method may further include building an artificial intelligence model according to a first update dataset by modeling and training the artificial intelligence model using the first update dataset, wherein, in the determining of whether the artificial intelligence model performance is converged, whether the artificial intelligence model performance is converged may be determined based on a difference between an output of the artificial intelligence model built according to the first update dataset and the label of the first update dataset.

The artificial intelligence model updating method may further include selecting a second update dataset from the entire dataset; generating a label of the second update dataset based on the output of the artificial intelligence model built according to the first update dataset; and building an artificial intelligence model according to the second update dataset by modeling and training the artificial intelligence model using the second update dataset, wherein, in the determining of whether the artificial intelligence model performance is converged, whether the artificial intelligence model performance is converged may be determined between the multiple artificial intelligence models based on the outputs of the multiple artificial intelligence models including the artificial intelligence model built according to the first update dataset and the artificial intelligence model built according to the second update dataset.

In the determining of whether the artificial intelligence model performance is converged, whether the artificial intelligence model performance is converged may be determined based on pattern changes of valid losses of the multiple artificial intelligence models, a valid loss of the artificial intelligence model according to the first update dataset may be calculated from a difference between the label of the first update dataset and multiple outputs of the artificial intelligence model obtained by inputting validation dataset of the first update dataset to the artificial intelligence model trained using the first update dataset, and a valid loss of the artificial intelligence model according to the second update dataset may be calculated from a difference between the label of the second update dataset and multiple outputs of the artificial intelligence model obtained by inputting validation dataset of the second update dataset to the artificial intelligence model trained using the second update dataset.

The artificial intelligence model updating method may further include selecting one artificial intelligence model among the multiple artificial intelligence models based on a valid loss of each of the multiple artificial intelligence models, when the artificial intelligence model performance is converged between the multiple artificial intelligence models, wherein, after the one artificial intelligence model is selected, the at least one task may be performed using the selected one artificial intelligence model.

In the determining of whether the artificial intelligence model performance is converged, whether the artificial intelligence model performance is converged may be determined based on the change patterns of the valid losses of the multiple artificial intelligence models and change patterns of valid accuracies of the multiple artificial intelligence models, valid accuracy of the artificial intelligence model built according to the first update dataset may be calculated from a number of outputs that match the first update dataset among multiple outputs of the artificial intelligence model obtained by inputting the validation dataset of the first update dataset to the artificial intelligence model trained using the first update dataset, and valid accuracy of the artificial intelligence model built according to the second update dataset may be calculated from a number of outputs that match the second update dataset among multiple outputs of the artificial intelligence model obtained by inputting the validation dataset of the second update dataset to the artificial intelligence model trained using the second update dataset.

The building of the artificial intelligence model according to the first update dataset may include: training the modeled artificial intelligence model according to multiple hyperparameters using the first update dataset; determining whether the artificial intelligence model performance according to the first update dataset is converged based on the output of the artificial intelligence model trained using the first update dataset; and adjusting the multiple hyperparameters according to whether the artificial intelligence model performance according to the first update dataset is converged, and the adjustment of the multiple hyperparameters and the training of the artificial intelligence model using the first update dataset may be repeatedly performed until the artificial intelligence model performance according to the first update dataset is converged.

According to another aspect of the present disclosure, a computer-readable recording medium in which a program for performing the artificial intelligence model automatic building method by a computer is recorded.

According to another aspect of the present disclosure, an artificial intelligence model updating device includes a data collection unit configured to collect a new dataset generated by performing at least one task using an artificial intelligence model trained using an initial dataset; a data selection unit configured to select an update dataset from entire dataset consisting of multiple unit data of the initial dataset and multiple unit data of the collected new dataset; a data labeling unit configured to generate a label of the update dataset based on an output of the artificial intelligence model trained using the initial dataset; and a controller configured to determine whether an artificial intelligence model performance is converged based on a difference between an output of an artificial intelligence model trained using the update dataset and a label of the update dataset, wherein a process of reselecting the update dataset and generating a label of the reselected update dataset is performed repeatedly until the artificial intelligence model performance is converged.

### BRIEF DESCRIPTION OF THE DRAWINGS

Embodiments will be more clearly understood from the following detailed description taken in conjunction with the accompanying drawings in which:

FIG. 1 is a configuration diagram of an artificial intelligence model updating device according to an embodiment of the present disclosure;

FIG. 2 is a flowchart of an artificial intelligence model updating method according to an embodiment of the present disclosure;

FIG. 3 is a detailed flowchart of step 21 and step 27 illustrated in FIG. 2;

FIG. 4 is an example view of a home screen among output screens of a user interface 10 illustrated in FIG. 1;

FIG. 5 is an example diagram of a dataset selection screen among the output screens of the user interface 10 illustrated in FIG. 1;

FIGS. 6A, 6B, and 7 are example diagrams of modeling elements of ae modeling unit 62 illustrated in FIG. 1;

FIG. 8 is an example diagram of a loss and accuracy display screen among the output screens of the user interface 10 illustrated in FIG. 1;

FIG. 9 is a detailed flowchart of step 25 illustrated in FIG. 2;

FIG. 10 is a diagram illustrating an execution example of step 25 illustrated in FIG. 2; and

FIG. 11 is a diagram illustrating an automatic labeling process of a data labeling unit 50 illustrated in FIG. 1.

### DETAILED DESCRIPTION OF THE EMBODIMENTS

Hereinafter, embodiments of the present disclosure are described in detail with reference to the drawings. The embodiments of the present disclosure described below relate to a method and device for updating an artificial intelligence model such that a prediction result of high accuracy may be provided with an optimal and efficient structure even when there is a change in equipment or environment of an industrial infrastructure to which the artificial intelligence model is applied based on automatic labeling.

Hereinafter, the method and the device are respectively and briefly referred to as an “artificial intelligence model updating method” and an “artificial intelligence model updating device”.

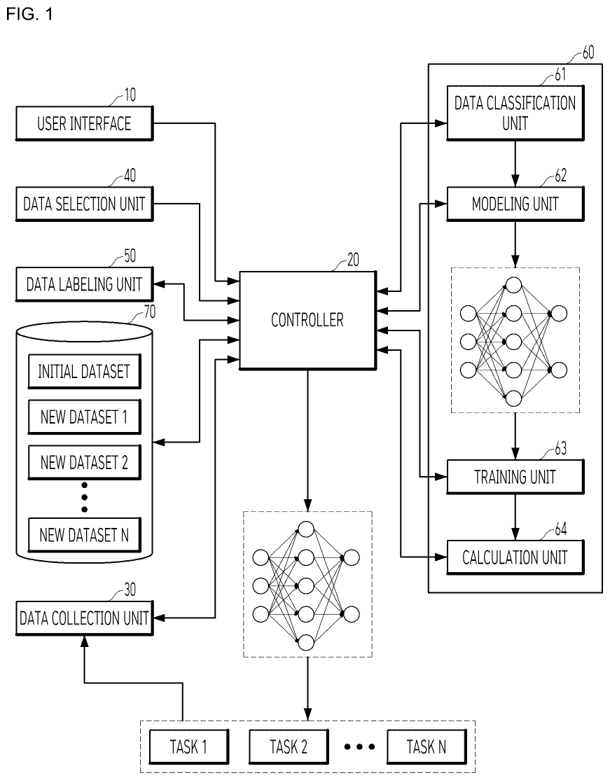

FIG. 1 is a configuration diagram of an artificial intelligence model updating device according to an embodiment of the present disclosure. Referring to FIG. 1, an artificial intelligence model updating device according to the present embodiment includes a user interface 10, a controller 20, a data collection unit 30, a data selection unit 40, a data labeling unit 50, a model building unit 60, and a storage 70. Here, the model building unit 60 includes a data classification unit 61, a modeling unit 62, a training unit 63, and a calculation unit 64. In order to make the present embodiment easy to understand while preventing the features of the present embodiment from being obscured, essential components of the present embodiment are illustrated in FIG. 1. Those skilled in the art to which the present embodiments belong may understand that other components may be added to the present embodiments in addition to the components illustrated in FIG. 1.

The user interface 10 receives a command or information from a user or outputs a video, an image, a text, and so on. The user interface 10 may be implemented by a display panel, a touch screen, or so on. The controller 20 controls an operation of at least one of the data collection unit 30, the data selection unit 40, the data labeling unit 50, and the model building unit 60 according to a user's command or information input through the user interface 10, or controls operations of other components according to a data processing result of one of the data collection unit 30, the data selection unit 40, the data labeling unit 50, and the model building unit 60.

The controller 20, the data collection unit 30, the data selection unit 40, the data labeling unit 50, and the model building unit 60 may be implemented by a combination of a processor and a computer program, or may be implemented by a field programmable gate array (FPGA). The storage 70 stores data, which is required for building an artificial intelligence model according to the present embodiment, for example, multiple datasets. The storage 70 may store a computer program for implementing at least one of the controller 20, the data collection unit 30, the data selection unit 40, the data labeling unit 50, and the model building unit 60. The storage 70 may be implemented by a combination of random access memory (RAM), read only memory (ROM), a solid state drive (SSD), and so on.

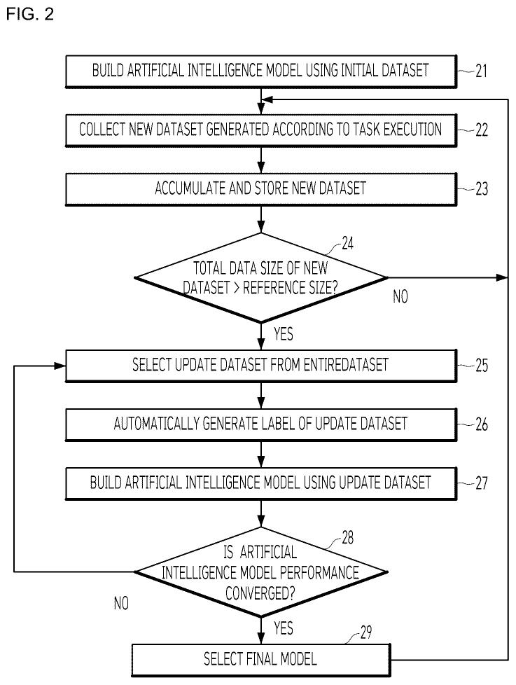

FIG. 2 is a flowchart of an artificial intelligence (AI) model updating method according to an embodiment of the present disclosure. Referring to FIG. 2, the AI model updating method according to the present embodiment includes the following steps performed by the AI model updating device illustrated in FIG. 1. Hereinafter, the AI model updating device illustrated in FIG. 1 is described in detail with reference to FIG. 1 and FIG. 2. In the present embodiment, an AI model building process includes a process of modeling an AI model and a process of training the AI model modeled in this way. According to the present embodiment, the AI model building process is automatically performed without user intervention.

In step 21, the model building unit 60 builds an AI model according to an initial dataset by modeling and training the AI model using the initial dataset. For example, when the AI model is used for a task of inspecting errors in circuit patterns of an integrated circuit or a printed circuit board, the initial dataset may be multiple images of various types of circuit patterns. In this case, a label of the initial dataset may be a value indicating whether there is an error in a circuit pattern represented by each image or may be the type of error.

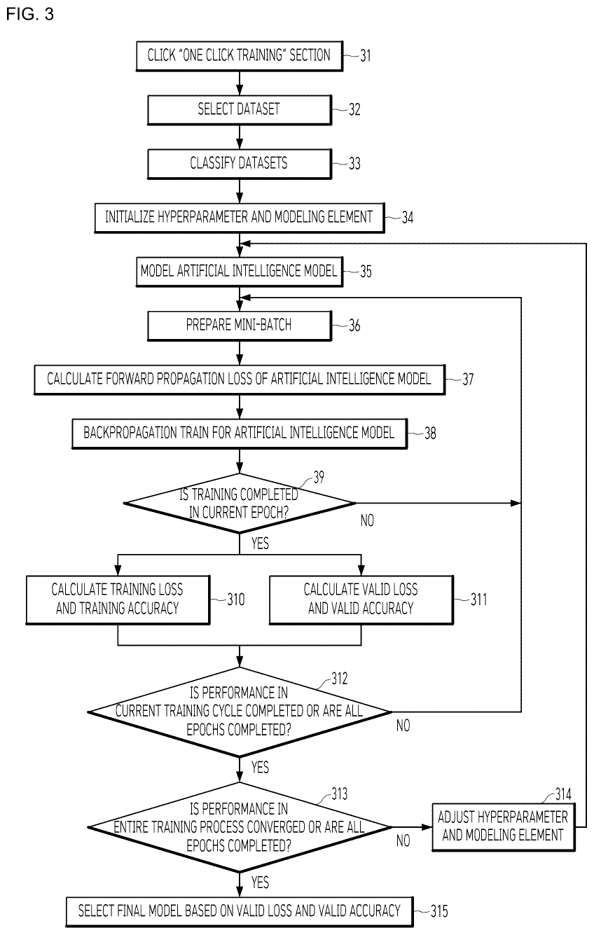

FIG. 3 is a detailed flowchart of step 21 illustrated in FIG. 2. Referring to FIG. 3, step 21 includes the following steps performed by the model building unit 60 and the controller 20 illustrated in FIG. 1. Hereinafter, the AI model updating device illustrated in FIG. 1 is described in detail with reference to FIG. 1 and FIG. 2. In the present embodiment, the AI model building process includes a process of modeling an AI model and a process of training the AI model modeled in this way. According to the present embodiment, the AI model building process is automatically performed without user intervention.

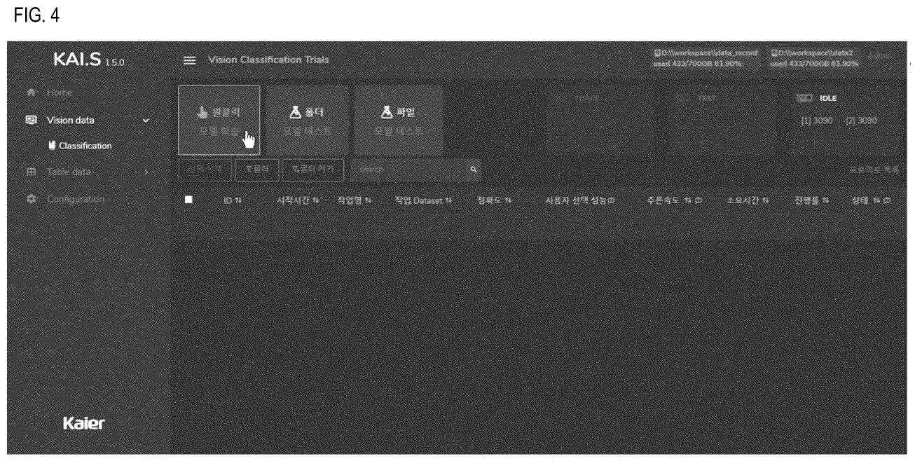

In step 31, the controller 20 generates home screen content for user interaction required to build an AI model, and outputs a home screen according to the home screen content generated in this way through the user interface 10. Subsequently, the controller 20 receives a command to start building an AI model from a user who recognizes the home screen output in this way through the user interface 10. FIG. 4 is an example view of a home screen among output screens of the user interface 10 illustrated in FIG. 1. A user may input a command to start building an AI model to the user interface 10 by clicking on a “one-click model training” section among several sections on the home screen of FIG. 4.

In step 32, the controller 20 generates screen content for selecting one of multiple datasets, and outputs a dataset selection screen according to the generated screen content through the user interface 10. Subsequently, the controller 20 receives a selection of one of the multiple datasets from a user who recognizes the dataset selection screen output in this way through the user interface 10. When using an AI model for a task of inspecting errors in circuit patterns of integrated circuits or printed circuit boards, the controller 20 receives a selection of an initial dataset including multiple images obtained by shooting various types of circuit patterns.

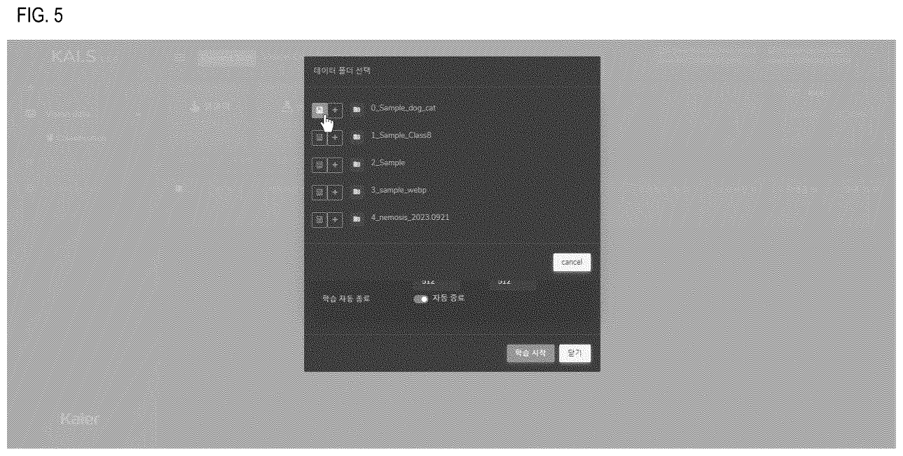

FIG. 5 is an example view of a dataset selection screen among output screens of the user interface 10 illustrated in FIG. 1. The dataset selection screen of FIG. 5 displays multiple directories in which multiple datasets are stored. A user may select one of the multiple datasets by clicking on one of the multiple directories displayed on the dataset selection screen of FIG. 5.

Each directory stores each dataset and a label of each dataset. Each dataset includes multiple pieces of unit data, and the label of each dataset includes at least one label value. For example, each unit data may be data of a circuit pattern image having a 5×5. Here, the image having a size of 5×5 indicates an image having a horizontal length of 5 pixels and a vertical length of 5 pixels, that is, an image consisting of a total of 35 pixels. Hereinafter, any one dataset selected by a user may be referred to as an initial dataset.

In step 33, the data classification unit 61 classifies initial datasets into training datasets and validation datasets. Some of datasets are used for training datasets and validation datasets. For example, the training unit 63 may randomly extract some of the initial datasets and classify some of the extracted datasets as training datasets. Subsequently, the training unit 63 classifies the other datasets excluding the training datasets as test datasets. The data classification unit 61 may also classify the initial datasets into training datasets, validation datasets, and test datasets. The test datasets may be used to measure the performance of an AI model built according to the present embodiment. The performance of an AI model or the AI model performance refers to an indicator of how accurately and quickly the AI model may provide a prediction result for input data.

In step 34, the controller 20 receives a command to start training an AI model using the initial dataset from a user through the user interface 10. When the command to start training an AI model is received from a user, the controller 20 initializes multiple hyperparameters and multiple modeling elements for building the AI model. The controller 20 may initialize the multiple hyperparameters and the multiple modeling elements by setting values of the multiple hyperparameters and multiple modeling elements to preset initial values.

For example, a hyperparameter may include a learning rate, a batch size, the epoch number, and so on. The learning rate refers to the amount of update of each weight of an AI model when updating each weight such that loss calculated from a difference between an output of the AI model and a label corresponding to the output is minimized. The less the learning rate, the more finely each weight is changed. The batch size refers to a division size of a training dataset for smooth training of the AI model, and the training dataset is divided into the number of mini-batches corresponding to the batch size. For example, in a case where the training dataset includes 1000 pieces of unit data, when the batch size is 10, the 1000 pieces of unit data are divided into 10 mini-batches. In this case, each mini-batch includes 100 pieces of unit data.

The epoch number refers to training repetition number of times of the AI model for all training datasets. In each epoch, AI model training is performed once for all the training datasets. For example, when the epoch number is 50, the AI model training for all training datasets is performed 50 times. In summary of the examples described above, when the AI model training is performed for 100 pieces of unit data of one mini-batch, the training for that mini-batch is completed. When the AI model training for the other 9 mini-batches is completed, training for one epoch is completed. When the AI model training for the other 49 epochs is completed through the same process, the AI model training according to the batch size and epoch number set in step 34 is completed.

A representative example of multiple modeling elements for an AI model may include the neuron number of each layer of a multi-layer perceptron (MLP) model, the layer number of the MLP model, the number of convolutional layers and pooling layers in a convolutional neural network (CNN) model, a feature map size of each convolutional layer in the CNN model, the neuron number of each layer of a fully connected (FC) layer in the CNN model, the layer number of the FC layer, and so on. In addition to the modeling elements listed above, there may be other modeling elements for the AI model. A structure of the AI model is determined by the multiple modeling elements.

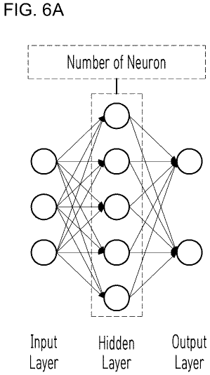

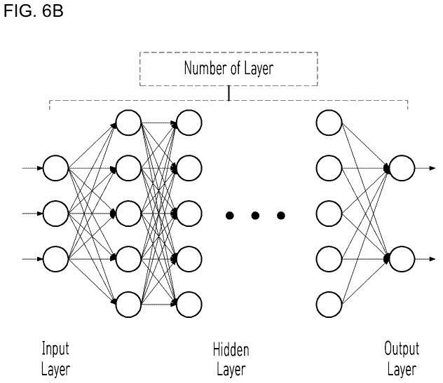

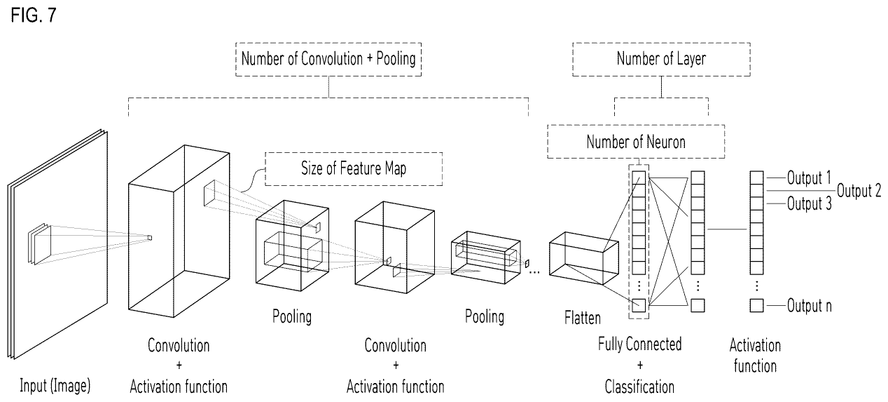

FIGS. 6A, 6B, and 7 are example diagrams of modeling elements of the modeling unit 62 illustrated in FIG. 1. FIG. 6A and FIG. 6B illustrates two modeling elements of an MLP model. Referring to FIG. 6A, the neuron number of each layer of the MLP model indicates how many neurons each layer, such as an output layer of the MLP model, at least one hidden layer, or an output layer, includes. Referring to FIG. 6B, the layer number of the MLP model indicates the total number of multiple layers, which constitute the MLP model, such as an output layer of the MLP model, at least one hidden layer, and an output layer.

FIG. 7 illustrates four modeling elements of a CNN model. Referring to FIG. 7, the number of convolutional and pooling layers of the CNN model indicates the total number of convolutional and pooling layers that are connected consecutively. A feature map size of each convolutional layer of the CNN model indicates a size of each feature map in each convolutional layer. The neuron number of each layer of an FC layer of the CNN model indicates how many neurons each layer of the FC layer includes. The layer number of the FC layer indicates how many layers the FC layer includes.

In step 35, the modeling unit 62 models an AI model according to the multiple modeling elements initialized in step 34 or adjusted in step 314. When the process proceeds from step 34 to step 35, the modeling unit 62 models the AI model according to the multiple modeling elements initialized in step 34. When the process proceeds from step 314 to step 35, the modeling unit 62 models the AI model according to the multiple modeling elements adjusted in step 314.

For example, when the layer number of the MLP model is set to 3, the neuron number of an input layer is set to 3, the neuron number of a hidden layer is set to 4, and the neuron number of an output layer is set to 2, the modeling unit 62 may model an AI model having a structure illustrated in FIG. 6A. The structure of the AI model most suitable for features of a dataset changes depending on the features of the datasets selected by a user. Therefore, in order to obtain an accurate prediction result of an AI model, the AI model having a structure suitable for the features of the dataset selected by the user has to be modeled.

For example, in a case where each unit data of a dataset represents a text and a label of the dataset is a value representing the meaning of the text, when unit data is input, an MLP model is suitable for an AI model to predict the meaning of the unit data. In this case, the neuron number of an input layer changes depending on a size of the text, the neuron number of an output layer changes depending on the diversity of meaning, and the layer number and neurons in the hidden layer and the neuron number change depending on difficulties of meaning prediction.

In a case where each unit data of a dataset represents an image and s label of the dataset is a value representing s shape of the image, when unit data is input, a CNN model is suitable for an AI model to predict a shape of the unit data. When an AI model is used for a task of checking errors in circuit patterns of integrated circuits or printed circuit boards, the CNN model is suitable. As in the example of the MLP model, values of the modeling elements change depending on sizes of an image input to the AI model, the variety of shapes predicted by an AI model, and the difficulty of shape prediction.

In step 36, the training unit 63 prepares a mini-batch to be used for the current epoch from the training dataset classified in step 33 according to the batch size initialized in step 34 or adjusted in step 314. The training dataset is divided into multiple mini-batches according to the batch size among the multiple hyperparameters initialized in step 34 or adjusted in step 314. For example, when the training dataset includes 1000 pieces of unit data and the batch size is 10, the training unit 63 may prepare a mini-batch including 100 pieces of unit data by extracting the 100 pieces of unit data from the other datasets excluding the datasets used for the previous training cycle among the 1000 pieces of unit data.

When the process is performed in the order of step 34, step 35, and step 36, the training unit 63 prepares a mini-batch to be used for the current epoch from the training dataset classified in step 36 according to the batch size initialized in step 34. When the process is performed in the order of step 314, step 35, and step 36, the training unit 63 prepares a mini-batch to be used for the current epoch from the training datasets classified in step 36 according to the batch size adjusted in step 314. In the present embodiment, the AI model training is performed by repeating step 36 to step 38. Here, the current epoch indicates one epoch, in which the AI model training is currently being performed, among the multiple epochs initialized in step 34 or according to the epoch number adjusted in step 314.

According to the present embodiment, an AI model is re-modeled whenever the multiple hyperparameters and multiple modeling elements are adjusted in step 314, and new training for an AI model based on the adjusted multiple hyperparameters starts again. In the present embodiment, a training section of an AI model based on the multiple hyperparameters and multiple modeling elements becomes one training cycle before the adjustment in step 314, and a new training cycle starts whenever adjustment is made in step 314. When the training cycle is repeated, the entire training process of an AI model becomes multiple training cycles. The current training cycle becomes the last training cycle in which training of an artificial neural network is currently being performed among the multiple training cycles, that is, a training cycle corresponding to multiple epochs according to the epoch number last adjusted in step 314.

In step 37, the training unit 63 obtains an output of an AI model according to an input of each unit data by inputting each unit data of the current mini-batch, which is a mini-batch prepared in step 36, to the AI model modeled by the modeling unit 62 in step 35, and calculates a forward propagation loss of the current mini-batch from a difference between an output of the AI model for each unit data obtained in this way and a label of the initial dataset. The output of the AI model may be composed of at least one predicted value for each unit data, and the label of the initial dataset may be composed of at least one label value corresponding to at least one predicted value. The forward propagation loss of the current mini-batch may be calculated using a loss function, such as mean squared error (MSE).

In step 38, the training unit 63 trains the AI model by backpropagating the forward propagation loss of the current mini-batch calculated in step 37 through the AI model. In more detail, the training unit 63 trains the AI model by updating each of multiple weights of the AI model from an output layer of the AI model toward an input layer such that the forward propagation loss of the current mini-batch calculated in step 37 is reduced. In this way, in step 36, step 37, and step 38, the training unit 63 trains the AI model modeled in step 35 according to the multiple hyperparameters initialized in step 34 or adjusted in step 314 using the initial dataset.

In step 39, the controller 20 checks whether the AI model training for all the multiple mini-batches according to the batch size initialized in step 34 or adjusted in step 314 is completed in the current epoch, which is one of the multiple epochs in which the AI model training is currently being performed according to the epoch number initialized in step 34 or adjusted in step 314. When a result of the check in step 39 shows that the AI model training in the current epoch is completed, the process proceeds to step 310 and step 311. Otherwise, the process returns to step 36.

Until the AI model training in the current epoch is completed, step 36, step 37, and step 38 are repeated as many times as the batch size initialized in step 34 or adjusted in step 314. For example, when the batch size is 10, step 36, step 37, and step 38 are repeated 10 number of times until the AI model training in the current epoch is completed. In step 36, step 37, and step 38, the training unit 63 calculates a forward propagation loss of each mini-batch from a difference between an output of the AI model for each of the multiple mini-matches divided from the training dataset according to the batch size initialized in step 24 or adjusted in step 214 and a label of the initial dataset, and trains the AI model by backpropagating the forward propagation loss of each mini-batch calculated in this way through the AI model. In step 310, the calculation unit 64 calculates a training loss and training accuracy of the current epoch. The calculation unit 64 may calculate a training loss of the current epoch by calculating an average of the forward propagation losses calculated for all the multiple mini-batches according to repetition of step 37 as much as the batch size initialized in step 34 or adjusted in step 314. The calculation unit 64 may calculate training accuracy of the current epoch from the number of outputs that match the label of the initial dataset among multiple outputs of the AI model obtained for all the multiple mini-batches by repeating step 37.

For example, when 10 forward propagation losses were calculated from 10 mini-batches in the current epoch, the calculation unit 64 may calculate a training loss of the current epoch by calculating an average of the 10 forward propagation losses. When the total number of multiple outputs of an AI model according to repetition of training for each mini-batch in the current epoch is 20 and the number of outputs that match a label of a dataset among the multiple outputs of the AI model is 10, the training accuracy is 50%.

In step 311, the calculation unit 64 calculates a valid loss and valid accuracy of the current epoch. The calculation unit 64 obtains an output of the AI model according to the input of each unit data by inputting each unit data of a validation dataset classified in step 33 to an artificial neural network trained in step 36, step 37, and step 38, and calculates a valid loss of the current epoch from differences between the multiple outputs of an AI model for all pieces of the validation datasets obtained in this way and labels of the datasets selected by a user. The calculation unit 64 may calculate valid accuracy of the current epoch from the number of outputs that match a label of the initial dataset among the multiple outputs of an AI model obtained for all the validation datasets.

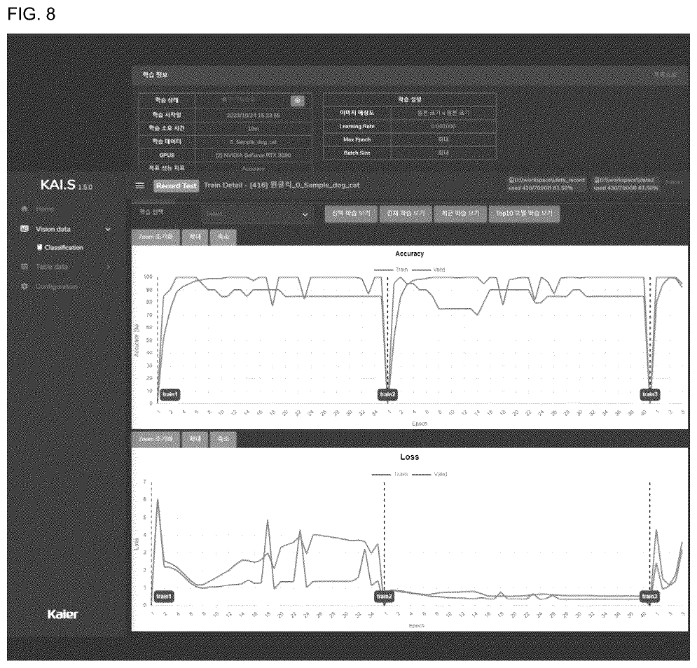

FIG. 8 is an example view of a loss and accuracy display screen among output screens of the user interface 10 illustrated in FIG. 1. Referring to FIG. 8, training loss and training accuracy, and valid loss and valid accuracy according to a training process of the AI model according to the present embodiment are displayed in the form of graphs. An upper graph shows training accuracy and valid accuracy, and a lower graph shows a training loss and a valid loss. An x-axis of each graph represents epoch accumulation according to training accumulation of an AI model, and a y-axis of each graph represents a loss and accuracy. In FIG. 8, “train1” corresponds to a first training cycle, “train2” corresponds to a second training cycle, and “train3” corresponds to a third training cycle.

In step 312, the controller 20 determines whether an AI model performance in the current training cycle is converged or whether training of the AI model for all epochs in the current training cycle is completed based on a training loss and training accuracy of the current epoch calculated by the calculation unit 64 in step 310 and training losses and training accuracies of multiple epochs prior to the current epoch calculated by the calculation unit 64. When the decision result in step 312 indicates that the AI model performance in the current training cycle is converged or that the training of the AI model for all epochs in the current training cycle is completed, the process proceeds to step 313. Otherwise, the process returns to step 36. That is, when the AI model performance in the current training cycle is before convergence and there are epochs in which training is not yet performed in the current training cycle, the process returns to step 36.

The training loss and training accuracy of the multiple epochs prior to the current epoch calculated by the calculation unit 64 indicates the training loss and training accuracy of the multiple epochs calculated in step 36 to step 310 that are repeatedly performed prior to step 36 to step 310 which are currently performed. All epochs of the current the currently performed cycle indicates all of the multiple epochs according to the epoch number in the current the currently performed cycle.

The controller 20 determines whether the AI model performance in the current the currently performed cycle is converged based on change patterns of the training loss of the current epoch and the training losses of the multiple epochs prior to the current epoch and change patterns of the training accuracy of the current epoch and the training accuracies of the multiple epochs prior to the current epoch. For example, in a case where the epoch number is 50, when AI model training is performed in 40 epochs from among the 50 epochs, the controller 20 may determine that the AI model performance in the current training cycle is converged when there is no increase in the training loss calculated from the last 5 epochs in which training is finally performed and there is no decrease in the training accuracy.

In step 313, the controller 20 determines whether the AI model performance in the entire training process consisting of the current training cycle and multiple training cycles prior to the current training cycle is converged or whether the AI model training for all epochs in the entire training process is completed. As a result of the decision at step 313, when the AI model performance in the entire training process is converged or the AI model training for all epochs in the entire training process is completed, the process proceeds to step 315. Otherwise, the process proceeds to step 314. That is, when the AI model performance in the entire training process is not yet converged and there are epochs, in which training is not yet performed, in the entire training process, the process proceeds to step 314.

The controller 20 determines whether the AI model performance is converged in the entire training process based on a change pattern of the training loss and a change pattern of the training accuracy in the current training cycle and a change pattern of the training loss and a change pattern of the training accuracy in each of multiple training cycles prior to the current training cycle. All epochs of the entire training process mean all epochs of the multiple training cycles that constitute the entire training process.

For example, when a training loss reduction slope indicated by a change pattern of a training loss in the current training cycle is less than a training loss reduction slope indicated by a change pattern of a training loss in a training cycle prior to the current training cycle, and when a training accuracy increase slope indicated by a change pattern of training accuracy in the current training cycle is less than a training accuracy increase slope indicated by a change pattern of training accuracy in a training cycle prior to the current training cycle, the controller 20 may determine that the AI model performance in the entire training process is converged.

As described above, the training loss and training accuracy in the present embodiment are calculated based on an output of an artificial neural network trained in step 36, step 37, and step 38, and accordingly, the controller 20 may determine, in step 312 and step 313, whether the AI model performance is converged based on the output of the AI model trained in step 36, step 37, and step 38. That is, the controller 20 may determine whether the AI model performance is converged based on a difference between the output of the artificial neural network trained in step 36, step 37, and step 38 and a label of an initial dataset.

In step 314, the controller 20 adjusts multiple hyperparameters and multiple modeling elements such that the training loss calculated from the preset number of multiple training cycles decreases and the training accuracy calculated therefrom increases, based on the change pattern of the training loss and the change pattern of the training accuracy, which are calculated from the preset number of multiple training cycles during the entire training process. As described above, when the AI model performance in the current training cycle is converged before the AI model performance in the entire training process is converged, the controller 20 adjusts multiple hyperparameters and multiple modeling elements.

An AI model is re-modeled according to the multiple modeling elements adjusted in this way, and the AI model is re-trained according to the multiple hyperparameters adjusted in this way. Adjustments of the multiple hyperparameters and multiple modeling elements and the training of an AI model are performed repeatedly until the AI model performance is converged. For example, when the preset number is 3, the controller 20 may adjust the multiple hyperparameters and multiple modeling elements such that the training loss calculated from the current training cycle and the previous two training cycles decreases and the training accuracy calculated therefrom increases, based on the change patterns of the training loss and the training accuracy calculated from the current training cycle, which is the last training cycle, and the previous two training cycles.

The controller 20 adjusts the multiple hyperparameters and the multiple modeling elements by changing a value of at least one of the multiple hyperparameters and the multiple modeling elements such that the training loss calculated from the preset number multiple training cycles decreases and the training accuracy calculated therefrom increases. For example, the controller 20 may change a batch size or the epoch number such that the training loss calculated from the preset number of multiple training cycles decreases and the training accuracy calculated therefrom increases, or may change the neuron number of each layer of an AI model or change the layer number of the AI model such that the training loss calculated from the preset number of multiple training cycles decreases and the training accuracy calculated therefrom increases.

In step 315, the controller 20 selects an AI model trained in one training cycle from among the AI models trained in each of multiple training cycles constituting the entire training process as the final authentication intelligence model based on multiple valid losses and multiple valid accuracies calculated from the multiple training cycles constituting the entire training process. According to the above description, one valid loss and one valid accuracy are calculated for each training cycle. Here, the multiple training cycles constituting the entire training process indicates the current training cycle in which the AI model training is last performed and all training cycles prior to the current training cycle. In this way, the AI model selected as the final AI model in step 315 becomes the AI model built in step 21, that is, the AI model built according to the initial dataset.

For example, the controller 20 determines a training cycle having three relatively small calculation unit losses among multiple calculation unit losses calculated from the multiple training cycles constituting the entire training process, determines a training cycle having the greatest training accuracy among three valid losses, and selects the AI model trained in the training cycle determined in this way as the final authentication intelligence model. According to the present embodiment, a process of adjusting multiple hyperparameters and a process of training an AI model according to the multiple hyperparameters using one dataset selected by a user are repeated until the AI model performance is converged, and thus, the multiple hyperparameters may be automatically adjusted to be optimized for the dataset selected by the user. A process of adjusting multiple modeling elements and a process of training an AI model modeled according to the multiple modeling elements using one dataset selected by a user are repeated until the AI model performance is converged, and thus, a structure of the AI model may be automatically adjusted to be optimized for the dataset selected by the user.

In this way, as a user simply selects any one of multiple datasets, training of an AI model having a structure optimized for the dataset selected by a user is performed according to the hyperparameter optimized for the dataset selected by the user, and thus, an AI model, which may provide a prediction result having very high accuracy with an optimal and efficient structure for the dataset selected by the user, may be automatically built. For example, an initial dataset corresponding to multiple images of various types of circuit patterns may be selected by a user, and an AI model that may provide a highly accurate prediction result with an optimal and efficient structure for the initial dataset may be automatically built.

In step 22, the data collection unit 30 collects a new dataset generated by performing at least one task using the AI model built by the model building unit 60 in step 21. For example, the AI model built in step 21 may be used for a task of inspecting errors in a circuit pattern of an integrated circuit or a printed circuit board, and the data collection unit 30 may collect a new dataset generated by performing a task of inspecting an error in a circuit pattern of an integrated circuit or a printed circuit board. At least one task performed using the AI model built in step 21 may include tasks of various processes for manufacturing an integrated circuit or a printed circuit board in addition to the task of inspecting the error in the circuit pattern of the integrated circuit or the printed circuit board.

A large number of manufacturing facilities and inspection apparatuses are used in large-scale manufacturing lines that repeatedly mass-manufacture integrated circuits or printed circuit boards. Due to precision limitations of manufacturing facilities, deterioration of the manufacturing facilities over time, and so on, errors inevitably occur in the circuit patterns of integrated circuits or printed circuit boards manufactured through manufacturing lines consisting of multiple manufacturing facilities. Errors that are not discovered during an initial operation of the manufacturing line may be discovered later, and new errors caused by deterioration of manufacturing facilities over time may be discovered.

Because the AI model built in step 21 is trained using an initial dataset generated before installation of a manufacturing line or during an initial operation of the manufacturing line, errors that are not discovered during the initial operation of the manufacturing line or new errors that occur due to deterioration of manufacturing facilities over time provide inaccurate prediction results. In the present embodiment, in order to enable an AI model to provide accurate prediction results on errors that are not discovered during an initial operation of a manufacturing line or on new errors that occur due to aging of the manufacturing facilities, the AI model built in step 21 collects a new dataset generated by performing at least one task.

When new data is generated in units of each unit data by performing at least one task using the AI model built in step 21, the data collection unit 30 may collect a new dataset by collecting each unit data one at a time. When new data is generated in units of multiple unit data by performing at least one task using the AI model built in step 21, the data collection unit 30 may also collect a new dataset by collecting multiple unit data at a time. For example, when an integrated circuit or a printed circuit board is output one by one through a manufacturing line, the data collection unit 30 may collect a new dataset by collecting one image obtained by shooting the integrated circuit or printed circuit board at a time. When multiple integrated circuits or printed circuit boards are output at a time through a manufacturing line, the data collection unit 30 may collect a new dataset by collecting multiple images obtained by shooting the integrated circuit or printed circuit board at a time.

In step 23, the controller 20 stores, in the storage 70, the new dataset collected by the data collection unit 30 in step 22. The controller 20 stores the new dataset collected in step 22 in the storage 70 by accumulating and storing the new dataset collected in step 22 in an initial dataset previously stored in the storage 70. When the new dataset collected before step 23 is stored in the storage 70 in addition to the initial dataset by repeating step 23, the controller 20 accumulates and stores the new dataset collected in step 22 in the initial dataset and new dataset previously stored in the storage 70. When data is collected in step 22 for each unit data, the storage 70 accumulates and stores new unit data one at a time. When data is collected in step 22 for each of multiple unit data, the multiple unit data are accumulated and stored in the storage 70 at once.

In step 24, the controller 20 checks whether the total data size of the new dataset accumulated and stored in the storage 70 is greater than a reference size. As a result of the checking in step 24, when the total data size of the new dataset accumulated and stored in the storage 70 is greater than the reference size, the process proceeds to step 25. Otherwise, the process returns to step 22 and additional collection of new datasets is performed. When the reference size is too large, it takes a long time to collect a new dataset that satisfies the reference size, and an update interval of an AI model becomes too wide, and accordingly, it can be difficult to respond to a change in an industrial infrastructure to which the AI model is applied, such as deterioration of manufacturing facilities over time. When the reference size is too small, sufficient training of the AI model is not performed, and thus, the AI model may not provide performance that a user satisfies. The reference size needs to be appropriately designed by considering features of the industrial infrastructure to which the AI model is applied.

In step 25, the data selection unit 40 selects an update dataset from entire dataset including multiple unit data of an initial dataset and multiple unit data of a new dataset collected by the data collection unit 30 in step 22. As described above, whenever a new dataset is collected by the data collection unit 30, the collected new dataset is accumulated and stored in the storage 70. When the total data size of the new data accumulated and stored in the storage 70 exceeds a certain size, the data selection unit 40 selects an update dataset from the initial dataset and the new dataset stored in the storage 70.

The AI model is re-modeled and trained using the update dataset selected in this way, and thus, the AI model according to the initial dataset is updated to the AI model according to the update dataset. By updating the AI model, the AI model may provide accurate prediction results in response to a change in the industrial infrastructure to which the AI model is applied, such as deterioration of manufacturing facilities over time. In other words, even when there is a change in the facilities or environment of the industrial infrastructure to which the AI model is applied, the AI model may always provide accurate prediction results. Also, the AI model may respond to any situation discovered late, such as a defect in a manufactured product or a defect in manufacturing facilities that is not discovered at the beginning of the industrial infrastructure installation, and may provide accurate prediction results.

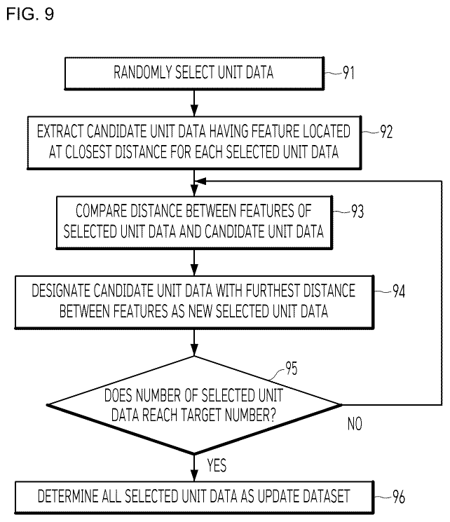

FIG. 9 is a detailed flowchart of step 25 illustrated in FIG. 2. Referring to FIG. 9, step 25 is an algorithm for selecting an update dataset from entire dataset and includes the following steps performed by the data selection unit 40 illustrated in FIG. 1. The data selection unit 40 selects an update dataset from entire dataset based on a feature difference between multiple unit datasets corresponding to some of entire dataset. Hereinafter, an operation of the data selection unit 40 is described in detail with reference to FIG. 9.

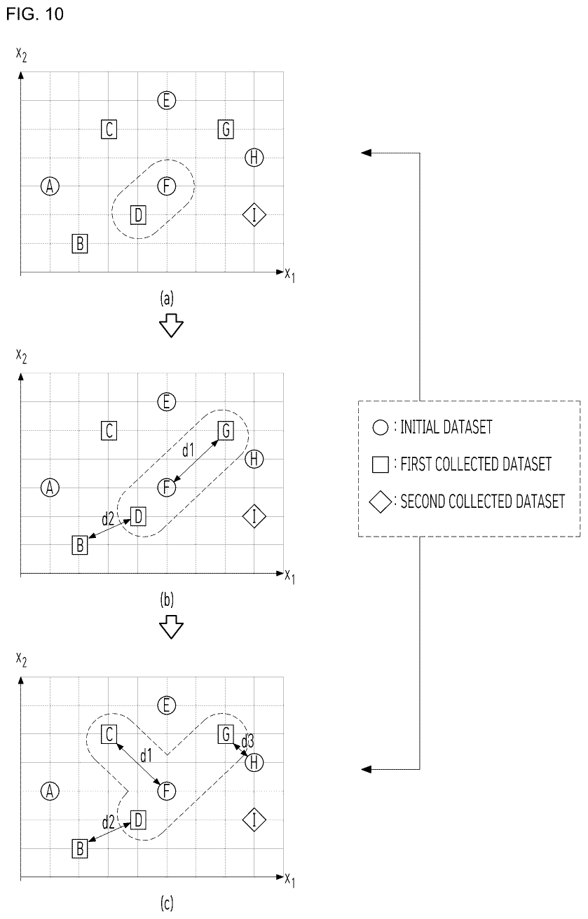

FIG. 10 is a diagram illustrating an execution example of step 25 illustrated in FIG. 2. FIG. 10 illustrates the execution example of step 25 when a feature space of an AI model is expressed as (x1,x2)T. In the feature space illustrated in FIG. 10, positions of features of nine piece of unit data, that is, unit data A to unit data I, are marked. In FIG. 10, circular unit data belongs to initial datasets, square unit data belongs to newly collected datasets for the first time, and rhombic unit data belongs to newly collected datasets for the second time. In FIG. 1, “new dataset 1” represents a newly collected dataset for the first time, and “new dataset 2” represents a newly collected dataset for the second time.

In the present embodiment, the feature of each unit data refers to a feature vector of each unit data extracted by an AI model which is built in step 21 and receives each unit data, that is, the AI model selected as the final AI model in step 315. For example, when each unit data is image-type data, the feature of each unit data may be a feature vector of each unit data extracted by a convolution layer and a pooling layer of a CNN model, that is, a feature vector input to an FC layer. The data selection unit 40 may obtain the feature of each unit data by inputting each unit data to the AI model built in step 21.

In the present embodiment, the AI model may be updated for the first time using the newly collected dataset and then updated for the second time using the newly collected dataset. That is, when the total data size of the new dataset accumulated and stored in the storage 70 is greater than a reference size, the AI model is updated, and then when the total data size of the new dataset newly accumulated and stored in the storage 70 is greater than the reference size, the AI model is updated again. Here, the initial dataset and the previously accumulated new dataset become the existing dataset. This process is continuously repeated.

In step 91, the data selection unit 40 randomly selects at least one unit data from among some of entire dataset consisting of initial datasets and the new datasets stored in the storage 70, and designates at least one unit data randomly selected in this way as the first selected unit data. For example, the data selection unit 40 may randomly select one or two pieces of unit data from among some of entire dataset, and designate one or two pieces of unit data randomly selected in this way as the first selected unit data.

In (a) of FIG. 10, unit data F is designated as first selected unit data. The unit data having a feature located at the closest distance to the feature of unit data F is “D”. In this case, there is no target for comparing a distance between features, and accordingly, unit data D automatically becomes the next selected unit data according to an algorithm illustrated in FIG. 10. The data selection unit 40 may also designate two pieces of unit data having features that are located closest to each other as the first selected unit data. Hereinafter, it is assumed that multiple unit data are designated as the first selected unit data in step 91, and subsequent steps are described.

In step 92, the data selection unit 40 extracts candidate unit data having a feature located at the closest distance from features of each selected unit data for each of the multiple selected unit data, which are the multiple unit data designated as the first selected unit data in step 91. When step 92 is repeated, the data selection unit 40 extracts candidate unit data having a feature located at the closest distance from the features of each selected unit data for each of the multiple unit data, which are the multiple unit data designated as the selected unit data in step 91 and step 94.

The data selection unit 40 extracts candidate unit data having a feature located at the closest distance from the features of each selected unit data for each of the multiple selected unit data among some of entire dataset excluding the multiple unit data previously designated as the selected unit data. In the example illustrated in (b) of FIG. 10, the unit data having the feature located at the closest distance from the feature of the selected unit data F is “G”, and the unit data having the feature located at the closest distance from the feature of the selected unit data D is “B”. In this case, the data selection unit 40 extracts the unit data G as the candidate unit data for the selected unit data F, and extracts the unit data D as the candidate unit data for the selected unit data B. In step 93, the data selection unit 40 compares a distance between the feature of each selected unit data and the feature of the candidate unit data extracted for each selected unit data in step 92 for all of the multiple selected unit data, which are the multiple unit data designated as the initial selected unit data in step 91. When step 92 is repeated, the data selection unit 40 compares a distance between the feature of each selected unit data and the candidate unit data extracted for each selected unit data in step 92 for each of the multiple selected unit data designated in step 91 and step 94. For example, the data selection unit 40 may sort the distances between the features of the multiple selected unit data and the candidate unit data in order of size, and compare the distances between the features sorted in this way.

In step 94, the data selection unit 40 additionally designates the candidate unit data with the furthest distance between the features among the multiple candidate unit data extracted for the multiple selected unit data in step 92 as a new selected unit data according to a result of the comparison of the distances between the features in step 93. According to the example illustrated in (b) of FIG. 10, a distance “d1” between the feature of the selected unit data F and the feature of the candidate unit data G is greater than a distance “d2” between the feature of the selected unit data B and the feature of the candidate unit data D. In this case, the data selection unit 40 additionally designates the candidate unit data G as new selected unit data. When the process is performed until here, the update dataset is composed of the multiple unit data F and D designated as selected unit data and the multiple unit data G additionally designated as new selected unit data. The portions surrounded by dotted lines in (a), (b), and (c) of FIG. 10 indicate sets of selected unit data designated so far.

In step 95, the data selection unit 40 checks whether the total number of multiple unit data designated as the initial selected unit data in step 91 and multiple unit data additionally designated as the new selected unit data in step 94, that is, the total number of multiple unit data designated as the selected unit data in step 91 and step 94, reaches a preset target number. When the total number of unit data designated as the selected unit data reaches the preset target number as a result of the checking in step 95, the process proceeds to step 96. Otherwise, the process returns to step 92. That is, when the total number of unit data designated as the selected unit data does not reach the preset target number, step 92, step 93, and step 94 are repeated until the preset target number is reached.

(c) of FIG. 10 illustrates an example in which additionally designated selected unit data is provided when returning to step 92 in (b) of FIG. 10. The unit data having the feature located at the closest distance from the feature of the selected unit data F is “C”, the unit data having the feature located at the closest distance from the feature of the selected unit data D is “B”, and the unit data having the feature located at the closest distance from the feature of the selected unit data G is “H”. In this case, the data selection unit 40 selects the unit data C as candidate unit data for the selected unit data F, selects the unit data D as candidate unit data for the selected unit data B, and selects the unit data H as candidate unit data for the selected unit data G.

The distance “d1” between the feature of the selected unit data F and the feature of the candidate unit data C is greater than the distance “d2” between the feature of the selected unit data B and the feature of the candidate unit data D, and is greater than a distance “d3” between the feature of the selected unit data G and the feature of the candidate unit data H. In this case, the data selection unit 40 additionally designates candidate unit data C as new selected unit data.

In step 96, the data selection unit 40 determines the multiple unit data designated as the initial selected unit data in step 91 and the multiple unit data additionally designated as new selected unit data while step 94 is repeated, that is, all pieces of unit data designated as the selected unit data in step 91 and step 94 that are repeated, as an update dataset. By determining the update dataset in this way, the update dataset may be selected from entire dataset.

Prediction accuracy of an AI model is determined by quality of a dataset used for training the AI model. In other words, the prediction accuracy of the AI model changes depending on how evenly the unit data with different features are distributed in the dataset rather than the entire data size of the dataset. Even when the entire data size of the dataset is large, when most of the multiple unit data constituting the dataset are biased toward a specific feature, the prediction accuracy of the AI model is decreased. As illustrated in FIG. 10, according to a data selection algorithm of the present embodiment, prediction accuracy of an AI model may be greatly increased because the unit data with different features are evenly distributed in the update dataset.

In step 26, the data labeling unit 50 generates a label of the update dataset by setting at least one label value for each of the multiple unit data belonging to the new dataset collected by the data collection unit 30 in step 22 among the multiple unit data of the update dataset selected by the data selection unit 40 in step 25, based on an output of the AI model built in step 21 or step 27. The update dataset selected by the data selection unit 40 includes an initial dataset with a previously determined label. In the present embodiment, only the multiple unit data belonging to a new dataset excluding the initial dataset among entire dataset are automatically labeled.

When step 26 is performed for the first time, that is, when step 21 to step 26 are performed and step 26 is performed, the data labeling unit 50 generates a label of the update dataset by setting at least one label value for each of multiple unit data belonging to the new dataset collected by the data collection unit 30 in step 22 based on an output of the AI model built in step 21, that is, the AI model selected as the final AI model in step 315 as step 21 is performed. When step 26 is performed repeatedly more than twice, that is, when the process proceeds from step 27 to step 22 and step 26 is performed, the data labeling unit 50 generates a label of the update dataset by setting at least one label value for each of the multiple unit data belonging to the new dataset collected by the data collection unit 30 in step 22 based on an output of the AI model built in step 27 and the AI model selected as the final AI model in step 315 as step 27 is performed.

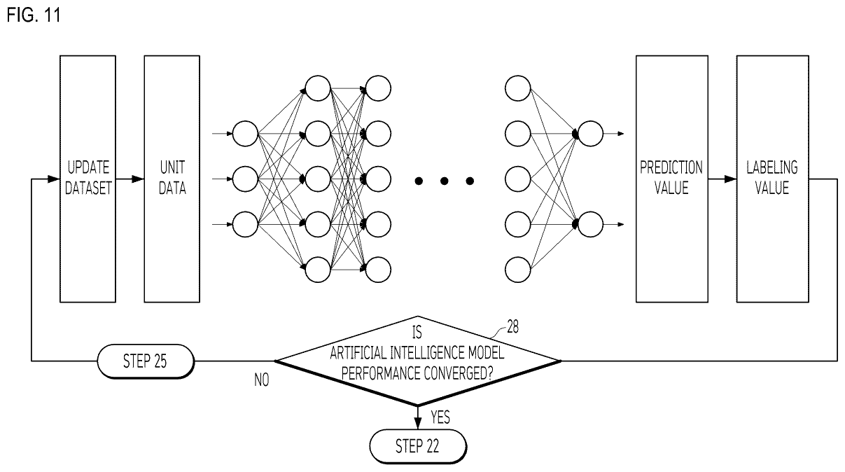

FIG. 11 is a diagram illustrating an automatic labeling process of the data labeling unit 50 illustrated in FIG. 1. Referring to FIG. 11, the data labeling unit 50 inputs each of multiple unit data belonging to the new dataset collected by the data collection unit 30 in step 22 to the AI model built in step 21 or step 27, thereby obtaining an output of the AI model according to an input of each unit data, and sets at least one label value of each unit data based on an output of the AI model for each unit data obtained in this way.

The output of the AI model may consist of at least one prediction value for each unit data. The data labeling unit 50 inputs each of multiple unit data belonging to the new dataset collected by the data collection unit 30 in step 22 to the AI model built in step 21 or step 27, thereby obtaining at least one prediction value for each unit data as an output of the AI model according to the input of each unit data, and sets at least one prediction value for each unit data obtained in this way as at least one label value of each unit data. In the present embodiment, each time step 26 is repeated, a label of the update dataset, that is, at least one label value of each unit data, is updated.

When step 25 to step 28 are performed once, the data selection unit 40 selects the first update dataset from entire dataset, and the data labeling unit 50 generates a label for the first update dataset based on an output of the AI model built according to the initial dataset. When step 25 to step 28 are performed twice, the data selection unit 40 selects the second update dataset from entire dataset, and the data labeling unit 50 generates a label for the second update dataset based on an output of the AI model built according to the first update dataset. When step 25 to step 28 are performed three times, the data selection unit 40 selects the third update dataset from entire dataset, and the data labeling unit 50 generates a label for the third update dataset selected in step 25 based on an output of the AI model built according to the second update dataset. In this way, the process of re-selecting the update dataset and the process of generating the label of the re-selected update dataset are repeated until the AI model performance is determined to be converged in step 28.

In step 27, the model building unit 60 builds an AI model according to the update dataset by modeling and training the AI model using the update dataset selected by the data selection unit 40 in step 25. In the example described above, when the update dataset selected in step 25 is the first update dataset, the model building unit 60 builds an AI model according to the first update dataset by modeling and training the AI model using the first update dataset. When the update dataset selected in step 25 is the second update dataset, the model building unit 60 builds an AI model according to the second update dataset by modeling and training the AI model using the second update dataset. When the update dataset selected in step 25 is the third update dataset, the model building unit 60 builds an AI model according to the third update dataset by modeling and training the AI model using the third update dataset.

Building of the AI model according to the update dataset by the model building unit 60 in step 27 is performed in the same process as the building of the AI model according to the initial dataset by the model building unit 60 in step 21. In the present embodiment, step 27 is automatically repeated without user intervention, and accordingly, step 31 and step 32 are omitted. That is, step 27 consists of step 33 to step 315 illustrated in FIG. 3. In step 34, the controller 20 immediately initializes multiple hyperparameters and multiple modeling elements for building an AI model after the dataset classification in step 33 without monitoring a user's training start command input. Hereinafter, the detailed process of step 27 is described mainly based on differences between step 33 to step 315 of step 21 and step 33 to step 315 of step 27 according to replacement of the initial dataset with the update dataset.

In step 36, step 37, and step 38, the training unit 63 trains the AI model modeled in step 35 according to multiple hyperparameters initialized in step 34 or adjusted in step 314 using the update dataset. In step 37, the training unit 63 obtains an output of an AI model according to an input of each unit data by inputting each unit data of the current mini-batch, which is a mini-batch prepared in step 36, to the AI model modeled by the modeling unit 62 in step 35, and calculates a forward propagation loss of the current mini-batch from a difference between an output of the AI model for each unit data obtained in this way and a label of the update dataset.

In step 310, the calculation 64 calculates training accuracy of the current epoch from the number of outputs that match the label of the update dataset among the multiple outputs of the AI model acquired for the entire number of mini-batches according to the repetition of step 37. In step 311, the calculation unit 64 calculates valid accuracy of the current epoch from the number of outputs that match the label of the update dataset among the multiple outputs of the AI model acquired for all validation datasets. In step 312 and step 313, the controller 20 determines whether performance of an AI model is converged based on differences between outputs of an artificial neural network trained in step 36, step 37, and step 38 and the labels of the update dataset.

For example, when step 33 to step 315 are performed for the first update dataset, step 33 to step 315 proceed as follows. In step 33, the data classification unit 61 classifies the first update datasets into training datasets and validation datasets. In step 34, the controller 20 initializes multiple hyperparameters and multiple modeling elements. In step 35, the modeling unit 62 models the AI model according to the multiple modeling elements initialized in step 34 or adjusted in step 314. In step 36, step 37, and step 38, the training unit 63 trains the AI model modeled in step 35 according to the multiple hyperparameters initialized in step 34 or adjusted in step 314 using the first update dataset.

In step 39, the controller 20 checks whether the AI model training is completed for all of the multiple mini-batches according to the batch size initialized in step 34 or adjusted in step 314 in the current epoch, that is one of epoch in which the AI model is currently being trained among multiple epochs according to the epoch number initialized in step 34 or adjusted in step 314. In step 310, the calculation unit 64 calculates a training loss and training accuracy of the current epoch. In step 311, the calculation unit 64 calculates a valid loss and valid accuracy of the current epoch.

In step 312, the controller 20 determines whether the AI model performance in the current training cycle is converged or whether the AI model training for all epochs in the current training cycle is completed, based on the training loss and training accuracy of the current epoch calculated by the calculation unit 64 in step 310 and the training loss and training accuracy of multiple epochs prior to the current epoch which are calculated by the calculation unit 64. In step 313, the controller 20 determines whether the AI model performance in the entire training process consisting of the current training cycle and multiple training cycles prior to the current training cycle is converged or whether the AI model training for all epochs of the entire training process is completed. Here, the AI model performance in the entire training process consisting of the current training cycle and the multiple training cycles prior to the current training cycle means the AI model performance according to the first update dataset.

In step 314, the controller 20 adjusts multiple hyperparameters and multiple modeling elements such that the training loss calculated from the preset number of multiple training cycles decreases and the training accuracy calculated therefrom increases, based on the change pattern of the training loss and the change pattern of the training accuracy, which are calculated from the preset number of multiple training cycles during the entire training process. In step 315, the controller 20 selects, as the final AI model, the AI model trained in one training cycle among AI models trained in each of multiple training cycles that constitute the entire training process, based on multiple valid losses and multiple valid accuracies calculated from the multiple training cycles that constitute the entire training process. According to the above description, the adjustment of the multiple hyperparameters and the training of the AI model using the first update dataset are repeatedly performed until the AI model performance according to the first update dataset is converged.

In step 28, the controller 20 determines whether the AI model performance is converged between the multiple AI models built in step 27 as step 27 is performed, based on differences between outputs of the multiple AI models built in step 27 as step 27 is repeatedly performed and the label of the update dataset used for training of each of multiple AI models. As a result of the determination in step 28, when the AI model performance is converged between the multiple AI models, the process proceeds to step 29. Otherwise, the process returns to step 25.

As in the above example, when step 27 is performed repeatedly three number of times, the controller 20 determines whether the AI model performance is converged between the multiple AI models built in step 27 as step 27 is repeated, based on a difference between an output of the AI model built according to the first update dataset and a label of the first update dataset, a difference between an output of the AI model built according to the second update dataset and a label of the second update dataset, a difference between an output of the AI model built according to the second update dataset and a label of the second update dataset, and a difference between an output of the AI model built according to the third update dataset and a label of the second update dataset.

The controller 20 determines whether the AI model performance is converged between the multiple AI models based on a change pattern of the valid loss of each of the multiple AI models built in step 27 as step 27 is performed repeatedly and a change pattern of the valid accuracy of the multiple AI models. The valid loss and the valid accuracy of each of the multiple AI models built in step 27 are used as the valid loss and the valid accuracy calculated in step 311. Each the multiple AI models built in step 27 is an AI model selected as the final AI model in step 315 as step 27 is performed, and accordingly, the valid loss and the valid accuracy of each the multiple AI models built in step 27 are the valid loss and the valid accuracy of the training cycle corresponding to the AI model selected as the final AI model in step 315.

As in the above example, when step 27 is performed three number of times, the controller 20 determines whether the AI model performance is converged among the AI model built according to the first update dataset, the AI model built according to the second update dataset, and the AI model built according to the third update dataset. In the present example, the valid loss of the AI model built according to the first update dataset is calculated from a difference between a label of the first update dataset and multiple outputs of the AI model obtained by inputting the validation dataset among the first update datasets to the AI model trained using the first update dataset. The valid loss of the AI model built according to the second update dataset is calculated from a difference between a label of the second update dataset and the multiple outputs of the AI model obtained by inputting the validation dataset among the second update datasets to the AI model trained using the second update dataset and. The valid loss of the AI model built according to the third update dataset is calculated from a difference between a label of the third update dataset and multiple outputs of the AI model obtained by inputting the validation dataset among the third update datasets to the AI model trained using the third update dataset.

The valid accuracy of the AI model built according to the first update dataset is calculated from the number of outputs that match the first update dataset among the multiple outputs of the AI model obtained by inputting the validation dataset among the first update datasets to the AI model trained using the first update dataset. The valid accuracy of the AI model built according to the second update dataset is calculated from the number of outputs that match the second update dataset among the multiple outputs of the AI model obtained by inputting the validation dataset among the second update datasets to the AI model trained using the second update dataset. The valid accuracy of the AI model built according to the third update dataset is calculated from the number of outputs that match the second update dataset among the multiple outputs of the AI model obtained by inputting the validation dataset among the third update datasets to the AI model trained using the third update dataset.

For example, when step 25 to step 27 are repeated 10 number of times, 10 AI models are built. When a change pattern of the valid loss of three AI models most recently built in step 27 indicates that the valid loss no longer decreases, and when a change pattern of the valid accuracy of the three AI models most recently built in step 27 indicates that the valid accuracy no longer increases, the controller 20 may determine that the AI model performance is converged between multiple AI models built in step 27 as step 27 is repeated. It is preferable that whether performances of several AI models which are most recently built in step 27 are determined to be converged are appropriately designed by considering a load of a computer to which the present embodiment is applied and the AI model performance finally selected in step 29.

In step 29, the controller 20 selects one AI model from among the multiple AI models built in step 27 as step 27 is performed repeatedly based on the valid loss and valid accuracy of each of the multiple AI models built in step 27 as step 27 is repeatedly performed. For example, the controller 20 determines an AI model having three valid losses of relatively small size among valid losses of multiple AI models built in step 27, determines an AI model with the greatest training accuracy among three AI models with a valid loss, and selects the AI model determined in this way as the final AI model. After the selection of the final AI model in step 29, the process returns to step 22, and at least one task is performed using the AI model selected as the final AI model. In this way, the AI model according to the initial dataset is updated to the AI model selected as the final AI model.

According to the present embodiment, automatic labeling with an accuracy almost comparable to manual labeling performed by human may be performed by repeatedly performing a process of collecting a new dataset generated by performing at least one task using an AI model, selecting an update dataset from entire dataset consisting of multiple unit data of an initial dataset and a new dataset, generating a label of the update dataset based on an output of the AI model trained using the initial dataset, reselecting the update dataset and generating a label of the reselected update dataset until the AI model performance is converged.

In particular, even when there is a facility change or an environment change in an industrial infrastructure to which the AI model is applied, automatic labeling may be performed periodically according to the facility change or environment change, and accordingly, a manual labeling task required whenever there is the facility change or environment change in the industrial infrastructure to which the AI model is applied is not needed, and a labeling error due to mistake of an operator during a manual labeling process may be prevented. As a result, costs and manpower invested in maintaining an AI model according to the facility change or environment change in the industrial infrastructure may be greatly reduced.

In addition, an AI model is continuously updated to provide a highly accurate prediction result with an optimal and efficient structure for datasets that change according to a facility change or environment change in an industrial infrastructure to which the AI model is applied, based on the automatic labeling, and thus, an AI model performance may be constantly maintained at the highest level. In addition, the AI model may respond to any situation discovered late, such as a defect in a manufactured product or a defect in a manufacturing facility that is not discovered at the beginning of the industrial infrastructure installation, and may provide an accurate prediction result.

The present disclosure is not limited to the effects described above, and other effects may be derived from the present embodiments described above.

In addition, the AI model updating method according to one embodiment of the present disclosure described above may be implemented as a program executable by a computer processor, and may be performed by a computer that records and executes the program on a computer-readable recording medium. The computer includes all types of computers that may execute programs, such as a desktop computer, a laptop computer, a smartphone, and an embedded-type computer. In addition, the structure of data used in one embodiment of the present disclosure described above may be recorded on a computer-readable recording medium through various means. Computer-readable recording media include storage media, such as RAM, ROM, an SSD, magnetic storage media (for example, floppy disks, hard disks, and so on), and optical readable media (for example, compact disk (CD)-ROMs, digital video disks (DVDs), and so on).

The present disclosure is described above with reference to preferred embodiments thereof. Those skilled in the art to which the present disclosure belongs will appreciate that the present disclosure may be implemented in modified forms without departing from the essential characteristics of the present disclosure. Therefore, the disclosed embodiments should be considered from an illustrative rather than a limiting perspective. The scope of the present disclosure is set forth in the claims, not in the foregoing description, and all differences within the scope equivalent thereto should be construed as being included in the present disclosure.

What is claimed is:

1. An artificial intelligence model updating method comprising:
collecting a new dataset generated by performing at least one task using an artificial intelligence model trained using an initial dataset;
selecting an update dataset from entire dataset consisting of multiple unit data of the initial dataset and multiple unit data of the collected new dataset;
generating a label of the update dataset based on an output of the artificial intelligence model trained using the initial dataset; and
determining whether an artificial intelligence model performance is converged based on a difference between an output of an artificial intelligence model trained using the update dataset and a label of the update dataset,
wherein a process of reselecting the update dataset and generating a label of the reselected update dataset is performed repeatedly until the artificial intelligence model performance is converged.

2. The artificial intelligence model updating method of claim 1, wherein,
in the generating of the label of the update dataset, the label of the update dataset is generated by setting at least one label value for each of multiple unit data belonging to the collected new dataset among multiple unit data of the selected update dataset.

3. The artificial intelligence model updating method of claim 2, wherein,
in the generating of the label of the update dataset, by inputting each of multiple unit data belonging to the collected new dataset to the artificial intelligence model trained using the initial dataset, at least one prediction value for each unit data is obtained as an output of an artificial intelligence model according to the input of the each unit data, and at least one prediction value for the obtained each unit data is set as at least one label value for the each unit data.

4. The artificial intelligence model updating method of claim 1, further comprising:
building an artificial intelligence model according to the initial dataset by training the artificial intelligence model using the initial dataset,
wherein, in the selecting of the update dataset, a first update dataset is selected from the entire dataset,
in the generating of the label of the update dataset, a label of the first update dataset is generated based on the output of the artificial intelligence model built according to the initial dataset, and
in the determining of whether the artificial intelligence model performance is converged, whether the artificial intelligence model performance is converged is determined based on a difference between an output of an artificial intelligence model trained using the first update dataset and the label of the first update dataset.

5. The artificial intelligence model updating method of claim 4, further comprising:
building an artificial intelligence model according to a first update dataset by modeling and training the artificial intelligence model using the first update dataset,
wherein, in the determining of whether the artificial intelligence model performance is converged, whether the artificial intelligence model performance is converged is determined based on a difference between an output of the artificial intelligence model built according to the first update dataset and the label of the first update dataset.

6. The artificial intelligence model updating method of claim 5, further comprising:
selecting a second update dataset from the entire dataset;
generating a label of the second update dataset based on the output of the artificial intelligence model built according to the first update dataset; and
building an artificial intelligence model according to the second update dataset by modeling and training the artificial intelligence model using the second update dataset,
wherein, in the determining of whether the artificial intelligence model performance is converged, whether the artificial intelligence model performance is converged is determined between the multiple artificial intelligence models based on the outputs of the multiple artificial intelligence models including the artificial intelligence model built according to the first update dataset and the artificial intelligence model built according to the second update dataset.

7. The artificial intelligence model updating method of claim 6, wherein,
in the determining of whether the artificial intelligence model performance is converged, whether the artificial intelligence model performance is converged is determined based on pattern changes of valid losses of the multiple artificial intelligence models,
a valid loss of the artificial intelligence model according to the first update dataset is calculated from a difference between the label of the first update dataset and multiple outputs of the artificial intelligence model obtained by inputting validation dataset of the first update dataset to the artificial intelligence model trained using the first update dataset, and
a valid loss of the artificial intelligence model according to the second update dataset is calculated from a difference between the label of the second update dataset and multiple outputs of the artificial intelligence model obtained by inputting validation dataset of the second update dataset to the artificial intelligence model trained using the second update dataset.

8. The artificial intelligence model updating method of claim 6, further comprising:
selecting one artificial intelligence model among the multiple artificial intelligence models based on a valid loss of each of the multiple artificial intelligence models, when the artificial intelligence model performance is converged between the multiple artificial intelligence models,
wherein, after the one artificial intelligence model is selected, the at least one task is performed using the selected one artificial intelligence model.

9. The artificial intelligence model updating method of claim 7, wherein,
in the determining of whether the artificial intelligence model performance is converged, whether the artificial intelligence model performance is converged is determined based on the change patterns of the valid losses of the multiple artificial intelligence models and change patterns of valid accuracies of the multiple artificial intelligence models,
valid accuracy of the artificial intelligence model built according to the first update dataset is calculated from a number of outputs that match the first update dataset among multiple outputs of the artificial intelligence model obtained by inputting the validation dataset of the first update dataset to the artificial intelligence model trained using the first update dataset, and
valid accuracy of the artificial intelligence model built according to the second update dataset is calculated from a number of outputs that match the second update dataset among multiple outputs of the artificial intelligence model obtained by inputting the validation dataset of the second update dataset to the artificial intelligence model trained using the second update dataset.

10. The artificial intelligence model updating method of claim 5, wherein
the building of the artificial intelligence model according to the first update dataset includes: training the modeled artificial intelligence model according to multiple hyperparameters using the first update dataset; determining whether the artificial intelligence model performance according to the first update dataset is converged based on the output of the artificial intelligence model trained using the first update dataset; and adjusting the multiple hyperparameters according to whether the artificial intelligence model performance according to the first update dataset is converged, and
the adjustment of the multiple hyperparameters and the training of the artificial intelligence model using the first update dataset are repeatedly performed until the artificial intelligence model performance according to the first update dataset is converged.

11. A computer-readable recording medium in which a program for performing the artificial intelligence model automatic building method of claim 1 by a computer is recorded.

12. An artificial intelligence model updating device comprising:
a data collection unit configured to collect a new dataset generated by performing at least one task using an artificial intelligence model trained using an initial dataset;
a data selection unit configured to select an update dataset from entire dataset consisting of multiple unit data of the initial dataset and multiple unit data of the collected new dataset;
a data labeling unit configured to generate a label of the update dataset based on an output of the artificial intelligence model trained using the initial dataset; and
a controller configured to determine whether an artificial intelligence model performance is converged based on a difference between an output of an artificial intelligence model trained using the update dataset and a label of the update dataset,
wherein a process of reselecting the update dataset and generating a label of the reselected update dataset is performed repeatedly until the artificial intelligence model performance is converged.
